(19) United States
(12) Patent Application Publication
(10) Pub. No.: US 2004/0133738 A1
(43) Pub. Date: Jul. 8, 2004

(54) Command processing method and storage apparatus

(75) Inventor: Satoru Adachi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/655,574

(22) Filed: Sep. 4, 2003

(30) Foreign Application Priority Data
Sep. 5, 2002 (JP) 2002-260382

(51) Int. Cl. G06F 12/00

(52) U.S. Cl. 711/112; 711/167

(57) ABSTRACT

A command processing method compares a start sector of a read or write command received during a sequential process with a sequential process final sector and a sequential process maximum extension sector when the command received does not make a sequential access, by using the sequential process final sector which indicates a sector where the sequential process ends and the sequential process maximum extension sector which indicates an extensible range of the sequential process, when carrying out a read or write sequential process with respect to a recording medium; and continues the sequential process by queuing the read or write command received into a command queue, when the start sector on the recording medium is located at a position before the sequential process final sector or after the sequential process maximum extension sector as a result of the comparing.

### BACKGROUND OF THE INVENTION

This application claims the benefit of a Japanese Patent Application No.2002-260382 filed Sep. 5, 2002, in the Japanese Patent Office, the disclosure of which is hereby incorporated by reference.

1. Field of the Invention

The present invention generally relates to command processing methods and storage apparatuses, and more particularly to a command processing method which is capable of carrying out a sequential process, and to a storage apparatus which uses such a command processing method.

2. Description of the Related Art

The sequential process is a command processing technique which continuously executes a group of commands which require sequential access to recording media such as disks without interruption, so as to improve the command processing capacity. When the sequential process is carried out in the case of a read, data are successively transferred to a host unit in an order starting from the data which has been completely read from the disk, while sequentially executing a disk read access process. On the other hand, when the sequential process is carried out in the case of a write, a disk write access process is executed sequentially while receiving write data from the host unit.

Normally, in a case where a command queue holds only a single command or a command group which makes the sequential access, the disk access process is executed by regarding the single command or the command group as one command. In addition, if a sequential command is received with respect to the disk access process which is being executed, a command is added to the sequential process and executed, so that the sequential process is extended while the sequential command is received consecutively. If a non-sequential command is received, the command is queued into the command queue, and the extension of the sequential process is prohibited, so as to queue all of the received commands until the sequential process is completed.

The sequential process is completed when the disk access process is completed with respect to all commands which are added to extend the sequential process until the time when the non-sequential command is received. After the sequential process is completed, the command queue is searched, so as to start processing the command held by the command queue.

In a case where the command group which makes the sequential access and a command which make a random access are queued, the sequential command group is executed by the sequential process, but no command is added.

When the non-sequential command such as a random command is received during the sequential process or, the random command is already queued into the command queue, the extension of the sequential process is prohibited, and the commands received thereafter are all queued as random commands until the sequential process is completed. For this reason, even if a sequential command which may be added to the present sequential process is included in the received commands, the sequential command is executed as a random command after the sequential process is completed, to thereby deteriorate the performance of the command processing.

Particularly in a multi-initiator environment such as a Redundancy Arranged Intelligent Disk (RAID), when a command from a different second host unit makes an interrupt while a first host unit continues to issue the sequential command, the performance of the command processing is greatly deteriorated.

### SUMMARY OF THE INVENTION

Accordingly, it is a general object of the present invention to provide a novel and useful command processing method and storage apparatus, in which the problems described above are eliminated.

Another and more specific object of the present invention is to provide a command processing method and a storage apparatus, which can greatly improve the command processing speed without interrupting the sequential process, even when a command is issued from a different second host unit while a first host unit issues a sequential command group in the multi-initiator environment.

Still another object of the present invention is to provide a command processing method comprising the steps of (a) comparing a start sector of a read or write command received during a sequential process with a sequential process final sector and a sequential process maximum extension sector when the command received does not make a sequential access, by using the sequential process final sector which indicates a sector where the sequential process ends and the sequential process maximum extension sector which indicates an extensible range of the sequential process, when carrying out a read or write sequential process with respect to a recording medium; and (b) continuing the sequential process by queuing the read or write command received into a command queue, when the start sector on the recording medium is located at a position before the sequential process final sector or after the sequential process maximum extension sector as a result of the comparing in the step (a). According to the command processing method of the present invention, it is possible to greatly improve the command processing speed without interrupting the sequential process, even when a command is issued from a different second host unit while a first host unit issues a sequential command group in the multi-initiator environment.

A further object of the present invention is to provide a command processing method comprising the steps of (a) comparing a start sector of a read or write command received during a sequential process with a first pointer and a second pointer when the command received does not make a sequential access, by using the first pointer which indicates a sequential process final sector where the sequential process ends and the second pointer which indicates a sequential process maximum extension sector indicative of an extensible range of the sequential process, when carrying out a read or write sequential process with respect to a recording medium; and (b) continuing the sequential process by queuing the read or write command received into a command queue, when the start sector on the recording medium is located at a position before the sequential process final sector or after the sequential process maximum extension sector as a result of the comparing in the step (a). According to the command processing method of the present invention, it is possible to greatly improve the command processing speed without interrupting the sequential process, even when a command is issued from a different second host unit while a first host unit issues a sequential command group in the multi-initiator environment.

Another object of the present invention is to provide a storage apparatus comprising a comparing section to compare a start sector of a read or write command received during a sequential process with a sequential process final sector and a sequential process maximum extension sector when the command received does not make a sequential access, by using the sequential process final sector which indicates a sector where the sequential process ends and the sequential process maximum extension sector which indicates an extensible range of the sequential process, when carrying out a read or write sequential process with respect to a recording medium; and a processing section to continue the sequential process by queuing the read or write command received into a command queue, when the start sector on the recording medium is located at a position before the sequential process final sector or after the sequential process maximum extension sector as a result of the comparing in the comparing section. According to the storage apparatus of the present invention, it is possible to greatly improve the command processing speed without interrupting the sequential process, even when a command is issued from a different second host unit while a first host unit issues a sequential command group in the multi-initiator environment.

Still another object of the present invention is to provide a storage apparatus comprising a comparing section to compare a start sector of a read or write command received during a sequential process with a first pointer and a second pointer when the command received does not make a sequential access, by using the first pointer which indicates a sequential process final sector where the sequential process ends and the second pointer which indicates a sequential process maximum extension sector indicative of an extensible range of the sequential process, when carrying out a read or write sequential process with respect to a recording medium; and a processing section to continue the sequential process by queuing the read or write command received into a command queue, when the start sector on the recording medium is located at a position before the sequential process final sector or after the sequential process maximum extension sector as a result of the comparing in the step comparing section. According to the storage apparatus of the present invention, it is possible to greatly improve the command processing speed without interrupting the sequential process, even when a command is issued from a different second host unit while a first host unit issues a sequential command group in the multi-initiator environment.

A further object of the present invention is to provide a storage apparatus comprising comparing means for comparing a start sector of a read or write command received during a sequential process with a sequential process final sector and a sequential process maximum extension sector when the command received does not make a sequential access, by using the sequential process final sector which indicates a sector where the sequential process ends and the sequential process maximum extension sector which indicates an extensible range of the sequential process, when carrying out a read or write sequential process with respect to a recording medium; and processing means for continuing the sequential process by queuing the read or write command received into a command queue, when the start sector on the recording medium is located at a position before the sequential process final sector or after the sequential process maximum extension sector as a result of the comparing in the comparing means. According to the storage apparatus of the present invention, it is possible to greatly improve the command processing speed without interrupting the sequential process, even when a command is issued from a different second host unit while a first host unit issues a sequential command group in the multi-initiator environment.

Other objects and further features of the present invention will be apparent from the following detailed description when read in conjunction with the accompanying drawings.

### BRIEF DESCRIPTION OF THE DRAWINGS

FIG. 1 is a system block diagram showing an embodiment of a storage apparatus according to the present invention;

FIG. 2 is a diagram for explaining an access range of an added command with respect to a sequential process;

FIG. 3 is a flow chart for explaining a command process;

FIG. 4 is a flow chart for explaining a sequential end process;

FIG. 5 is a diagram for explaining a pointer setting at a read sequential process start point;

FIG. 6 is a diagram for explaining a pointer setting when a read sequential command is received during a read sequential process;

FIG. 7 is a diagram for explaining the pointer setting when a write sequential command is received during a read sequential process;

FIG. 8 is a diagram for explaining the pointer setting when a non-sequential read command is received during the read sequential process;

FIG. 9 is a diagram for explaining the pointer setting when a non-sequential write command is received during the read sequential process;

FIG. 10 is a diagram for explaining the pointer setting when a sequential read command is received during the read sequential process;

FIG. 11 is a diagram for explaining the pointer setting during a write sequential process; and

FIG. 12 is a diagram for explaining the pointer setting when a non-sequential command is received during the write sequential process.

### DESCRIPTION OF THE PREFERRED EMBODIMENTS

A description will be given of each embodiment of a command processing method according to the present invention and a storage apparatus according to the present invention, by referring to the drawings.

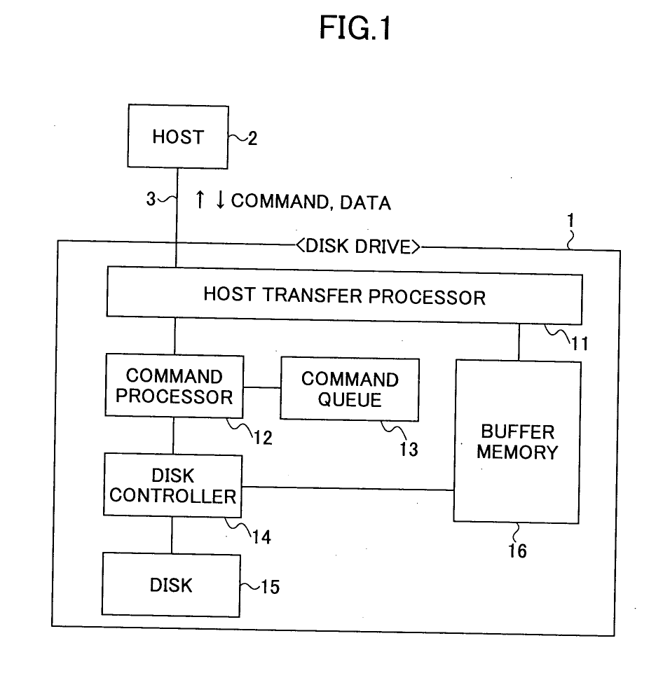

FIG. 1 is a system block diagram showing an embodiment of the storage apparatus according to the present invention. This embodiment of the storage apparatus employs an embodiment of the command processing method according to the present invention. In this embodiment, the present invention is applied to a disk drive.

In FIG. 1, a disk drive 1 is connected to a host unit 2 via a cable and/or wireless connecting means 3. The connecting means 3 may include one or more networks. The disk drive 1 includes a host transfer processor 11, a command processor 12, a command queue 13, a disk controller 14, a disk 15, and a buffer memory 16. The disk 15 is of a type which is capable of recording information thereon and reproducing information therefrom, and may be formed by a magnetic disk, an optical disk, a magneto-optical disk or the like. The disk 15 may be a portable type which is loaded to and unloaded from the disk drive 1 or, may be a fixed type which is fixedly accommodated within the disk drive 1. Of course, the present invention is not limited to the disk drive, and the present invention may use any type of recording media, other than the disk 15, that is capable of recording information thereon and reproducing information therefrom.

The host transfer processor 11 exchanges commands and data with the host unit 2. This host transfer processor 11 sends the command received from the host unit 2 to the command processor 12. In addition, this host transfer processor 11 links to the disk controller 14 via the buffer memory 16, so as to transfer the data from the host unit 2 to the disk controller 14 via the buffer memory 16, and to transfer the data read from the disk 15 to the host unit 2 via the buffer memory 16. Hence, the buffer memory 16 is used to temporarily store the data which are exchanged between the host unit 2 and the disk drive 1.

The command processor 12 analyzes the command received from the host unit 2, and executes the command by instructing processes to the host transfer processor 11 and the disk controller 14. When executing a read or write command, the command processor 12 analyzes a command property such as a random access and a sequential access, and analyzes a command hold state of a command queue, to instruct a read or write process to the disk controller 14.

The command queue 13 temporarily holds (queues) a command which cannot be executed immediately by the command processor 12 or, a command which is analyzed by the command processor 12 as being not executable immediately. By queuing the command into the command queue 13, the command processor 12 can change an executing order of the commands.

The disk controller 14 carries out the read or write process which is instructed by the command processor 12, with respect to the disk 15 which is used as the recording medium in this case. In the case of the read process, the disk controller 14 stores the data read from the disk 15 in the buffer memory 16. On the other hand, in the case of the write process, the disk controller 14 writes on the disk 15 the data which is stored in the buffer memory 16 by the host transfer processor 11.

A command processing apparatus, which is formed by a single chip, for example, and is provided with a function of carrying out a sequential process, includes at least the command processor 12 described above.

The basic structure itself of the disk drive 1 shown in FIG. 1 is known, and it is of course possible to employ other known basic structures instead.

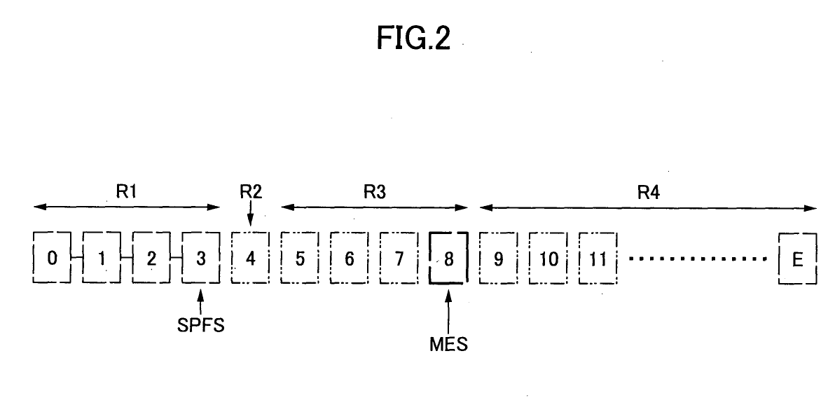

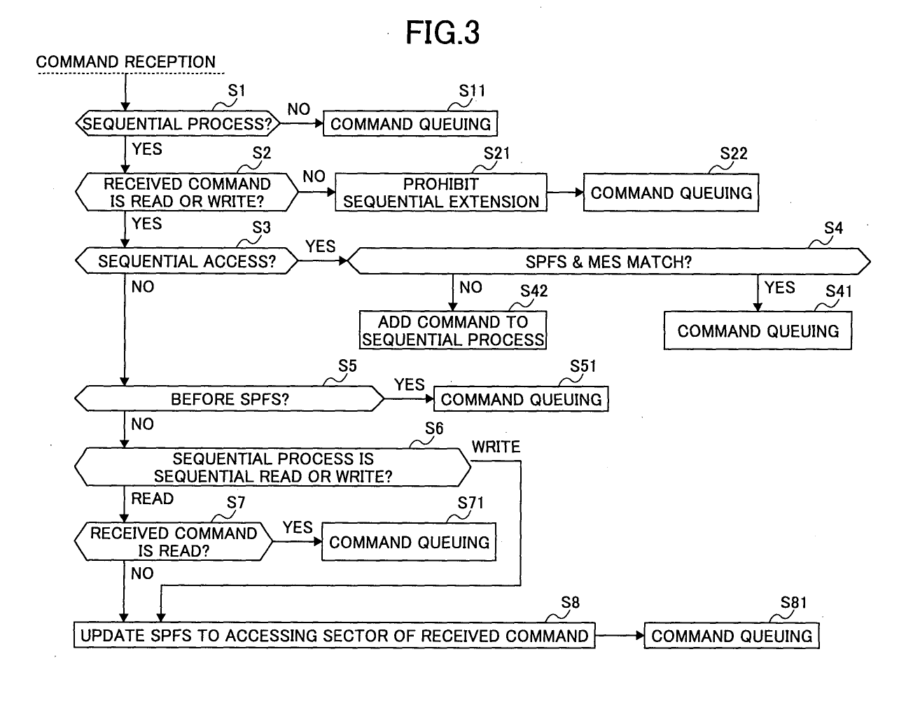

Next, a description will be given of the operation of this embodiment, by referring to FIGS. 2 and 3. FIG. 2 is a diagram for explaining a an access range of an added command with respect to a sequential process. FIG. 3 is a flow chart for explaining a command processing carried out by the command processor 12.

In FIG. 2 and FIGS. 5 through 12 which will be described later, “0”, “1”, . . . denote sector numbers on the disk 15, and “E” denotes a final (or end) sector. In the following description, a “sector 1”, for example, refers to the sector having the sector number “1”. In addition, AR1 through AR4 denote access ranges of the added command, SPFS denotes a sequential process final (or end) sector which indicates the final (or end) sector of the sequential process (that is, the sector where the sequential process ends), and MES denotes a sequential process maximum extension sector which indicates a maximum extensible range of the sequential process.

First, a description will be given of the general process of this embodiment. A final sector value of a command which is received at random is stored in the sequential process final sector SPFS, and the final sector E of the disk drive 1 is stored in the sequential process maximum extension sector MES. A sequential process is started if the next command is a sequential command.

The sequential process ends if the next sequential command is not issued until a disk access process to a sector which is indicated by a pointer of the sequential process final sector SPFS ends. The pointer of the sequential process final sector SPFS will hereinafter be referred to as a sequential process final sector pointer SPFSP.

In FIG. 3, a step S1 decides whether or not the sequential process is in progress. If the sequential process is not in progress and the decision result in the step S1 is NO, a step S11 queues the received command into the command queue 13. On the other hand, if the sequential process is in progress and a command is newly received, the decision result in the step S1 is YES, and a step S2 decides whether or not the received command is a read or write command. If the decision result in the step S2 is NO, a step S21 prohibits extension of the sequential process, and a step S22 queues the received command into the command queue 13. Since the sequential process is prohibited, commands received thereafter are all queued into the command queue 13.

On the other hand, if the decision result in the step S2 is YES, a step S3 decides whether or not a start sector of the received command is sequential with respect to the sector indicated by the sequential process final sector pointer SPFSP. If the decision result in the step S3 is YES, a step S4 compares the sequential process final sector pointer SPFSP and a pointer MESP of the sequential process maximum extension sector MESP (hereinafter referred to as a sequential process maximum extension sector pointer MESP), so as to determine whether or not the two compared pointers SPFSP and MESP match. If the two compared pointers SPFSP and MESP match, it is indicated that a command cannot be added with respect to the sequential process. Hence, if the decision result in the step S4 is YES, a step S41 prohibits extension of the sequential process and queues the received command into the command queue 13. On the other hand, if the two compared pointers SPFSP and MESP do not match and the decision result in the step S4 is NO, a step S42 updates the sequential process final sector pointer SPFSP to a value of the final sector of the received command, and adds the received command to the sequential process.

If the received command is not sequential and the decision result in the step S3 is NO, a step S5 decides whether or not the final sector of the received command is located at a position before the sector indicated by the sequential process final sector pointer SPFSP. If the decision result in the step S5 is YES, a step S51 queues the received command into the command queue 13, and executes the received command after the present sequential process ends. On the other hand, if the final sector of the received command is located at a position after the sector indicated by the sequential process final sector pointer SPFSP and the decision result in the step S5 is NO, a step S6 decides whether the present sequential process is a read sequential process or a write sequential process.

If the present sequential process is a write sequential process, the write sequential process which is extended thereafter must not be executed prior to the received command. Hence, in this case, a step S8 updates the sequential process maximum extension sector pointer MESP to a value which is obtained by subtracting “1” from the start sector (number) of the received command, and a step S81 queues the received command into the command queue 13.

On the other hand, if the present sequential process is a read sequential process, a step S7 decides whether or not the received command is a read command. If the decision result in the step S7 is YES, a step S71 queues the received command into the command queue 13. If the received command is a write command, the decision result in the step S7 is NO. If the decision result in the step S7 is NO, the read sequential process which is extended thereafter must not be executed prior to the received command. Hence, in this case, the step S8 updates the sequential process maximum extension sector pointer MESP to a value which is obtained by subtracting “1” from the start sector (number) of the received command, and the step S81 queues the received command into the command queue 13.

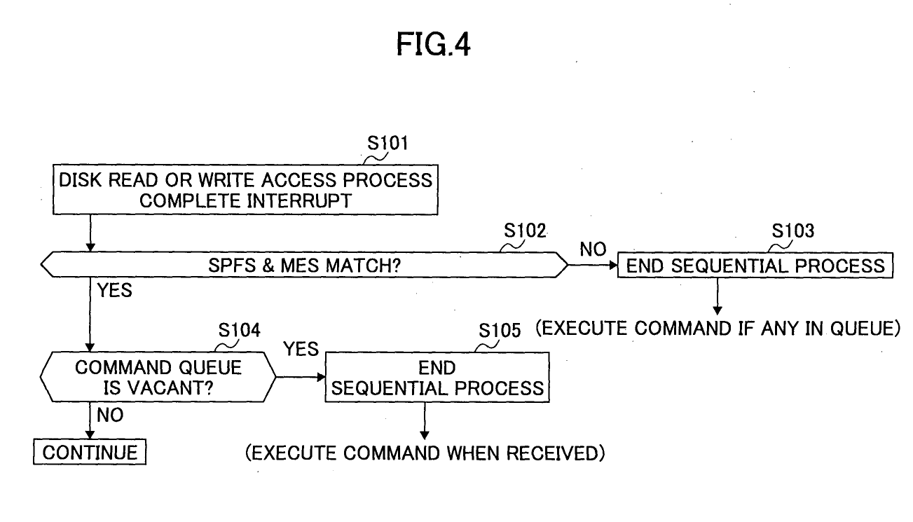

FIG. 4 is a flow chart for explaining a sequential end process carried out by the command processor 12. The sequential process is stopped by the sequential end process shown in FIG. 4.

In FIG. 4, a step S101 completes a disk read or write access process, and generates a disk read or write access process complete interrupt. A step S102 decides whether or not the sequential process final sector SPFS matches the sequential process maximum extension sector MES. If the decision result in the step S102 is NO, a step S103 executes a command in the command queue 13 if any, and the sequential process ends. On the other hand, if the decision result in the step S102 is YES, a step S104 decides whether or not the command queue 13 is vacant. The sequential process is continued if the decision result in the step S104 is NO. If the decision result in the step S104 is YES, a step S105 executes a command if received, and the sequential process ends.

By the command processing described above, it is possible to add a received command which is sequential while executing the sequential process, without having to stop the extension of the sequential process due to the reception of a random command.

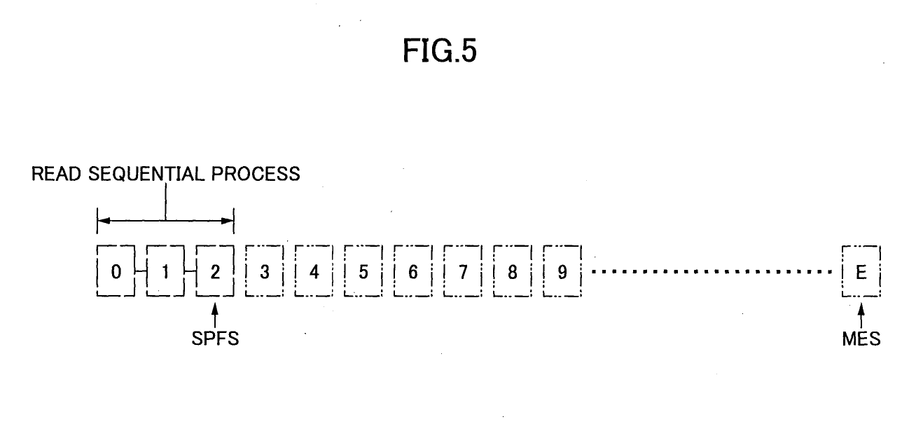

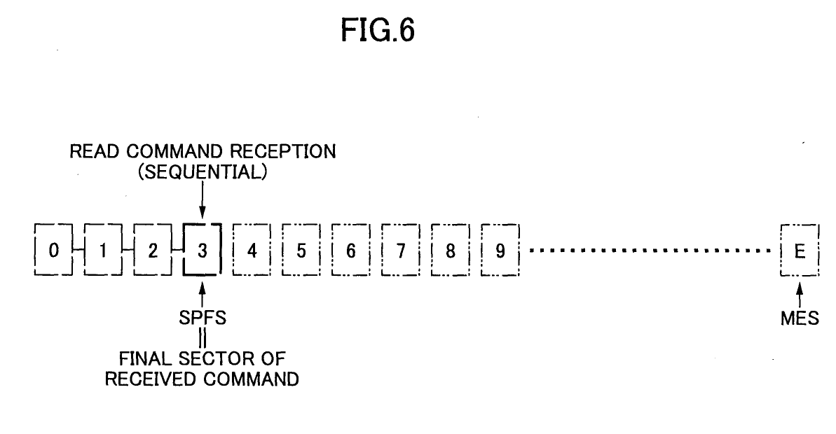

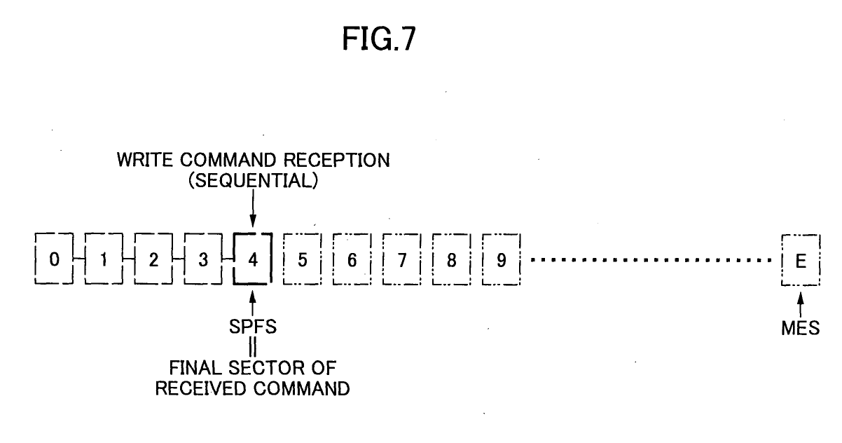

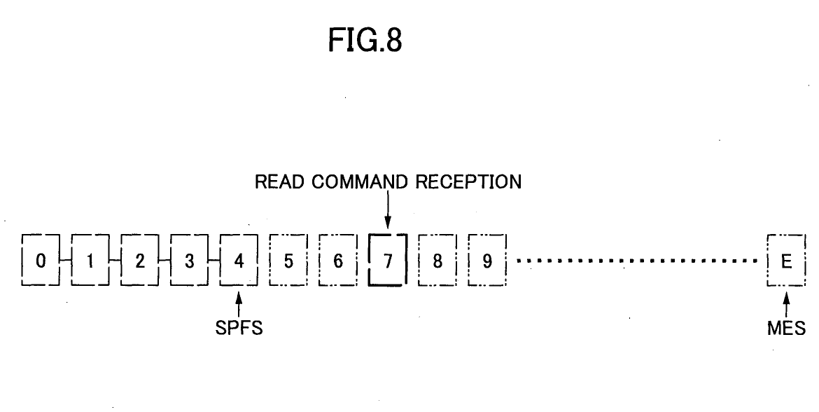

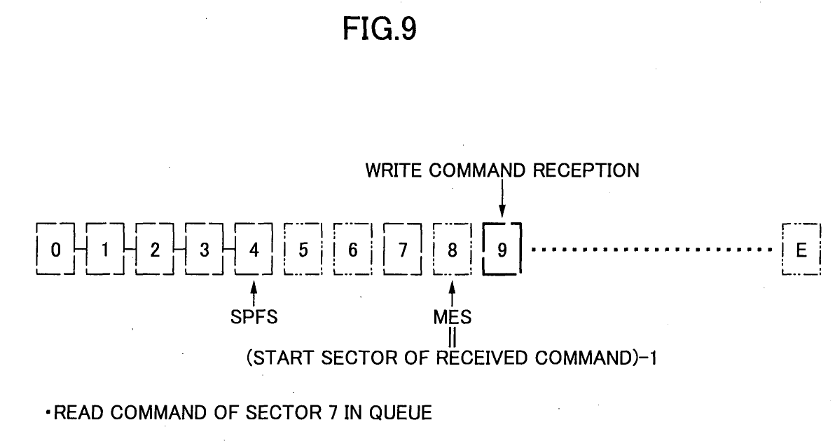

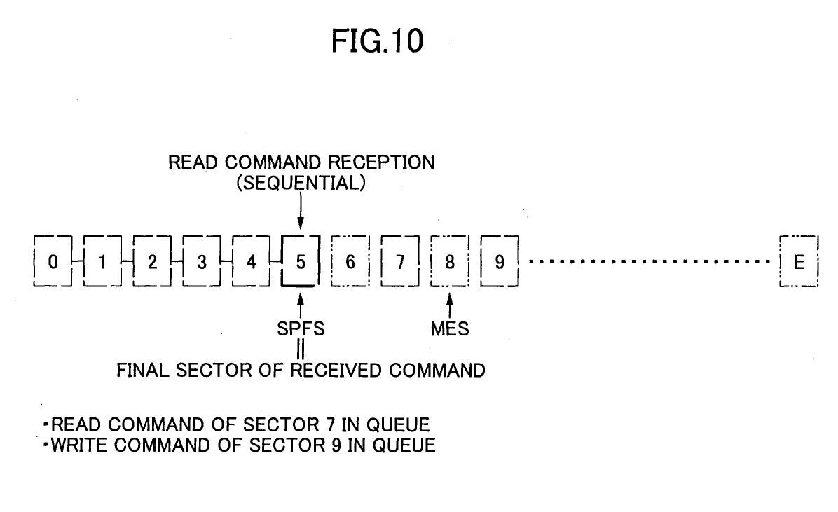

Next, a description will be given of the operation during the read sequential process, by referring to FIG. 3 and FIGS. 5 through 10. FIG. 5 is a diagram for explaining a pointer setting at a read sequential process start point. FIG. 6 is a diagram for explaining a pointer setting when a read sequential command is received during a read sequential process. FIG. 7 is a diagram for explaining the pointer setting when a write sequential command is received during a read sequential process. FIG. 8 is a diagram for explaining the pointer setting when a non-sequential read command is received during the read sequential process. FIG. 9 is a diagram for explaining the pointer setting when a non-sequential write command is received during the read sequential process. Further, FIG. 10 is a diagram for explaining the pointer setting when a sequential read command is received during the read sequential process.

As shown in FIG. 5, when a read sequential process by three read commands which read sectors 0, 1 and 2 on the disk 15 is started, the sector 2 is stored in the sequential process final sector pointer SPFSP, and the final sector E on the disk 15 is stored in the sequential process maximum extension sector pointer MESP.

If the disk drive 1 receives from the host unit 2 a read command which newly reads the sector 3 in the state shown in FIG. 5, the decision result in the step S1 shown in FIG. 3 becomes YES since it is during the sequential process. Because the received command is a read command, the decision result in the step S2 shown in FIG. 3 becomes YES. The sector 3, which is the start sector of the received read command, is sequential to the sector 2 indicated by the sequential process final sector pointer SPFSP, and the decision result in the step S3 shown in FIG. 3 becomes YES. In this case, the decision result in the step S4 shown in FIG. 3 becomes NO, because the sequential process final sector pointer SPFSP (stores the sector 2) and the sequential process maximum extension sector pointer MESP (stores the final sector E) do not match. Accordingly, the step S42 shown in FIG. 3 updates the value of the sequential process final sector pointer SPFSP to the sector 3 as shown in FIG. 6, and the sequential process is extended.

If the disk drive 1 receives from the host unit 2 a write command which newly writes the sector 4 in the state shown in FIG. 6, the decision result in the step S1 shown in FIG. 3 becomes YES since it is during the sequential process. Because the received command is a write command, the decision result in the step S2 shown in FIG. 3 becomes YES. The sector 4, which is the start sector of the received write command, is sequential to the sector 3 indicated by the sequential process final sector pointer SPFSP, and the decision result in the step S3 shown in FIG. 3 becomes YES. In this case, the decision result in the step S4 shown in FIG. 3 becomes NO, because the sequential process final sector pointer SPFSP (stores the sector 3) and the sequential process maximum extension sector pointer (MESP (stores the final sector E) do not match. Accordingly, the step S42 shown in FIG. 3 updates the value of the sequential process final sector pointer SPFSP to the sector 4 as shown in FIG. 7, and the sequential process is extended.

If the disk drive 1 receives from the host unit 2 a read command which newly reads the sector 7 in the state shown in FIG. 7, the decision result in the step S1 shown in FIG. 3 becomes YES since it is during the sequential process. Because the received command is a read command, the decision result in the step S2 shown in FIG. 3 becomes YES. The sector 7, which is the start sector of the received read command, is not sequential to the sector 4 indicated by the sequential process final sector pointer SPFSP, and the decision result in the step S3 shown in FIG. 3 becomes NO. In addition, the sector 7 is located at a position after the sector 4 indicated by the sequential process final sector pointer SPFSP, and the decision result in the step S5 shown in FIG. 3 becomes NO. The present sequential process is a read sequential process, and the step S7 shown in FIG. 3 is carried out after the step S6. The received command is a read command, and the decision result in the step S7 shown in FIG. 3 becomes YES. Hence, the step S71 shown in FIG. 3 queues the received command into the command queue 13, as shown in FIG. 8.

If the disk drive 1 receives from the host unit 2 a write command which newly writes the sector 9 in the state shown in FIG. 8, the decision result in the step S1 shown in FIG. 3 becomes YES since it is during the sequential process. Because the received command is a write command, the decision result in the step S2 shown in FIG. 3 becomes YES. The sector 9, which is the start sector of the received write command, is not sequential to the sector 4 indicated by the sequential process final sector pointer SPFSP, and the decision result in the step S3 shown in FIG. 3 becomes NO. In addition, the sector 9 is located at a position after the sector 4 indicated by the sequential process final sector pointer SPFSP, and the decision result in the step S5 shown in FIG. 3 becomes NO. The present sequential process is a read sequential process, and the step S7 shown in FIG. 3 is carried out after the step S6. The received command is a write command, and the decision result in the step S7 shown in FIG. 3 becomes NO. Hence, the step S8 shown in FIG. 3 updates the value of the sequential process maximum extension sector pointer MESP to a value which is obtained by subtracting “1” from the start sector of the received write command, that is, updates to the sector 8, as shown in FIG. 9.

If the disk drive 1 receives from the host unit 2 a read command which newly reads the sector 5 in the state shown in FIG. 9, the decision result in the step S1 shown in FIG. 3 becomes YES since it is during the sequential process. Because the received command is a read command, the decision result in the step S2 shown in FIG. 3 becomes YES. The sector 5, which is the start sector of the received read command, is sequential to the sector 4 indicated by the sequential process final sector pointer SPFSP, and the decision result in the step S3 shown in FIG. 3 becomes YES. In this case, the sequential process final sector pointer SPFSP (stores the sector 4) and the sequential process maximum extension sector pointer MESP (stores the sector 8) do not match, and the decision result in the step S4 shown in FIG. 3 becomes NO. Accordingly, the step S42 shown in FIG. 3 updates the value of the sequential process final sector pointer SPFSP to the sector 5 as shown in FIG. 10, and the sequential process is extended.

In the state shown in FIG. 9, the read command of the sector 7 is in queue in the command queue 13.

In addition, in the state shown in FIG. 10, the read command of the sector 7 is in queue in the command queue 13, and the write command of the sector 9 is in queue in the command queue 13.

Therefore, the sequential read or write command which is received during the read sequential process can be added to the sequential process until the sequential process final sector pointer SPFSP matches the sequential process maximum extension sector pointer MESP, without being interfered by a non-sequential command which is received during read the sequential process.

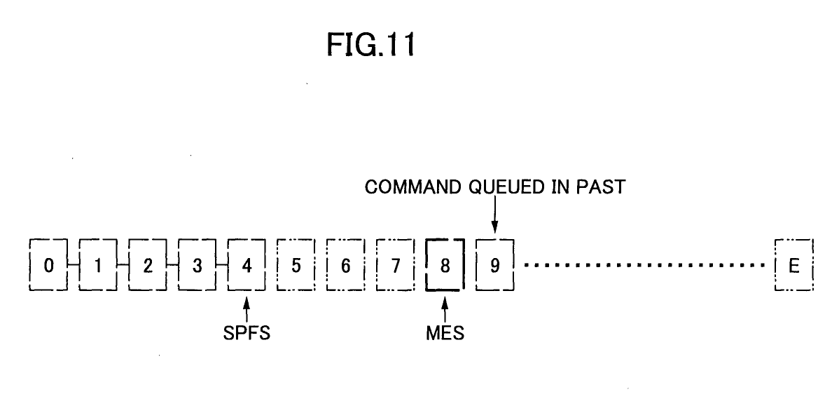

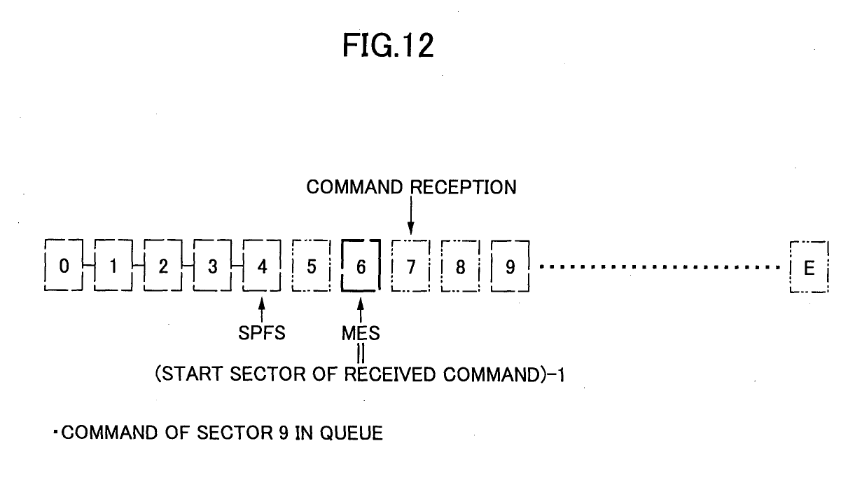

Next, a description will be given of the operation during the write sequential process, by referring to FIGS. 3, 11 and 12. FIG. 11 is a diagram for explaining the pointer setting during a write sequential process. FIG. 12 is a diagram for explaining the pointer setting when a non-sequential command is received during the write sequential process.

The write sequential process operates on the sequential process final sector pointer SPFSP and the sequential process maximum extension sector pointer MESP up to the step S7 shown in FIG. 3, similarly as in the case of the read sequential process.

If a command which causes the process to advance up to the step S7 shown in FIG. 3, such as a command accessing the sector 7, is received during the write sequential process as shown in FIG. 11, the step S8 shown in FIG. 3 updates the sequential process maximum extension sector pointer MESP to a value which is obtained by subtracting “1” from the start sector (number) of the received command, that is, updated to the sector 6 as shown in FIG. 12, at the point in time when the step S7 recognizes that the present sequential process is a write sequential process, because the write command must be executed in the received order.

In the state shown in FIG. 12, the command of the sector 9 is in queue in the command queue 13.

Therefore, the sequential read or write command which is received during the write sequential process can be added to the sequential process until the sequential process final sector pointer SPFSP matches the sequential process maximum extension sector pointer MESP, without being interfered by a random command which is received during write the sequential process.

Further, the present invention is not limited to these embodiments, but various variations and modifications may be made without departing from the scope of the present invention.

What is claimed is:

1. A command processing method comprising the steps of:
(a) comparing a start sector of a read or write command received during a sequential process with a sequential process final sector and a sequential process maximum extension sector when the command received does not make a sequential access, by using the sequential process final sector which indicates a sector where the sequential process ends and the sequential process maximum extension sector which indicates an extensible range of the sequential process, when carrying out a read or write sequential process with respect to a recording medium; and
(b) continuing the sequential process by queuing the read or write command received into a command queue, when the start sector on the recording medium is located at a position before the sequential process final sector or after the sequential process maximum extension sector as a result of the comparing in said step (a).

2. A command processing method comprising the steps of:
(a) comparing a start sector of a read or write command received during a sequential process with a first pointer and a second pointer when the command received does not make a sequential access, by using the first pointer which indicates a sequential process final sector where the sequential process ends and the second pointer which indicates a sequential process maximum extension sector indicative of an extensible range of the sequential process, when carrying out a read or write sequential process with respect to a recording medium; and
(b) continuing the sequential process by queuing the read or write command received into a command queue, when the start sector on the recording medium is located at a position before the sequential process final sector or after the sequential process maximum extension sector as a result of the comparing in said step (a).

3. The command processing method as claimed in claim 2, wherein the said step (b) continues the sequential process by queuing a read command which does not make a sequential access and is received during a read sequential process into the command queue, if a start sector of the read command received is located at a position between the sequential process final sector and the sequential process maximum extension sector as a result of the comparing in said step (a).

4. The command processing method as claimed in claim 2, wherein the said step (b) continues the sequential process by queuing a write command which does not make a sequential access and is received during a read sequential process into the command queue, after updating a value of the first pointer to a value which is obtained by subtracting 1 from a start sector number of the write command received, if a start sector of the write command received is located at a position between the sequential process final sector and the sequential process maximum extension sector as a result of the comparing in said step (a).

5. The command processing method as claimed in claim 2, wherein the said step (b) continues the sequential process by queuing a read or write command which does not make a sequential access and is received during a write sequential process into the command queue, after updating a value of the second pointer to a value which is obtained by subtracting 1 from a start sector number of the read or write command received, if a start sector of the read or write command received is located at a position between the sequential process final sector and the sequential process maximum extension sector as a result of the comparing in said step (a).

6. A storage apparatus comprising:
a comparing section to compare a start sector of a read or write command received during a sequential process with a sequential process final sector and a sequential process maximum extension sector when the command received does not make a sequential access, by using the sequential process final sector which indicates a sector where the sequential process ends and the sequential process maximum extension sector which indicates an extensible range of the sequential process, when carrying out a read or write sequential process with respect to a recording medium; and
a processing section to continue the sequential process by queuing the read or write command received into a command queue, when the start sector on the recording medium is located at a position before the sequential process final sector or after the sequential process maximum extension sector as a result of the comparing in said comparing section.

7. A storage apparatus comprising:
a comparing section to compare a start sector of a read or write command received during a sequential process with a first pointer and a second pointer when the command received does not make a sequential access, by using the first pointer which indicates a sequential process final sector where the sequential process ends and the second pointer which indicates a sequential process maximum extension sector indicative of an extensible range of the sequential process, when carrying out a read or write sequential process with respect to a recording medium; and
a processing section to continue the sequential process by queuing the read or write command received into a command queue, when the start sector on the recording medium is located at a position before the sequential process final sector or after the sequential process maximum extension sector as a result of the comparing in said step comparing section.

8. The storage apparatus as claimed in claim 7, wherein the said processing section continues the sequential process by queuing a read command which does not make a sequential access and is received during a read sequential process into the command queue, if a start sector of the read command received is located at a position between the sequential process final sector and the sequential process maximum extension sector as a result of the comparing in said comparing section.

9. The storage apparatus as claimed in claim 7, wherein the said processing section continues the sequential process by queuing a write command which does not make a sequential access and is received during a read sequential process into the command queue, after updating a value of the first pointer to a value which is obtained by subtracting 1 from a start sector number of the write command received, if a start sector of the write command received is located at a position between the sequential process final sector and the sequential process maximum extension sector as a result of the comparing in said comparing section.

10. The storage apparatus as claimed in claim 7, wherein the said processing section continues the sequential process by queuing a read or write command which does not make a sequential access and is received during a write sequential process into the command queue, after updating a value of the second pointer to a value which is obtained by subtracting 1 from a start sector number of the read or write command received, if a start sector of the read or write command received is located at a position between the sequential process final sector and the sequential process maximum extension sector as a result of the comparing in said comparing section.

11. A storage apparatus comprising:
comparing means for comparing a start sector of a read or write command received during a sequential process with a sequential process final sector and a sequential process maximum extension sector when the command received does not make a sequential access, by using the sequential process final sector which indicates a sector where the sequential process ends and the sequential process maximum extension sector which indicates an extensible range of the sequential process, when carrying out a read or write sequential process with respect to a recording medium; and
processing means for continuing the sequential process by queuing the read or write command received into a command queue, when the start sector on the recording medium is located at a position before the sequential process final sector or after the sequential process maximum extension sector as a result of the comparing in said comparing means.
